(19) United States
(12) Patent Application Publication
(10) Pub. No.: US 2006/0072019 A1
(43) Pub. Date: Apr. 6, 2006

(54) System and method for detecting image capture device movement with two dual axis linear accelerometers

(76) Inventors: Donald J. Stavely, Windsor, CO (US); Mark E. Wanger, Fort Collins, CO (US); James H. Anderson, Fort Collins, CO (US); Casey L. Miller, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/989,838

(22) Filed: Nov. 16, 2004

Related U.S. Application Data
(60) Provisional application No. 60/614,311, filed on Sep. 29, 2004.

(51) Int. Cl. H04N 5/228

(52) U.S. Cl. 348/208.99; 348/208.2

(57) ABSTRACT

A system and method for determining movement of an image capture device is disclosed. Briefly described, one embodiment comprises a first dual-axis linear accelerometer residing in the image capture device that senses a first acceleration in a first direction and that senses a first orthogonal acceleration in an orthogonal direction, a second dual-axis linear accelerometer residing in the image capture device that senses a second acceleration in the first direction and that senses a second orthogonal acceleration in the orthogonal direction, a processor that receives information from the first dual-axis linear accelerometer and the second dual-axis linear accelerometer such that the movement of the image capture device is determined.

### CROSS-REFERENCE TO RELATED APPLICATION

This application claims priority to copending U.S. provisional application entitled, “SYSTEM AND METHOD FOR DETECTING IMAGE CAPTURE DEVICE MOVEMENT WITH TWO DUAL AXIS LINEAR ACCELEROMETERS,” having ser. No. 60/614,311, filed Sep. 29, 2004, which is entirely incorporated herein by reference.

### TECHNICAL FIELD

Embodiments are generally related to image capture devices and, more particularly, are related to a system and method for detecting image capture device movement.

### BACKGROUND

Image capture devices may employ various devices to sense movement of the image capture device during image capture. Based upon the received information corresponding to movement, image data and/or image capture device components may be adjusted to result in capture of higher quality images.

A variety of sources may cause movement of the image capture device. For example, a photographer's hand may shake while the photographer is trying to capture an image. Or, the photographer may be afflicted with a physical disability or illness. Environmental factors such as wind may cause the movement. Or, the photographer and the image capture device may be in a vehicle moving over a rough surface, in an airplane traveling through rough weather, or on a boat in choppy water.

In some image capture devices, physical devices are employed to detect movement. Such physical devices provide information to a processing system that then generate instructions so that the image data and/or image capture device components may be adjusted. However, such physical devices may be limited by their number, cost and size. For example, a relatively large gyroscope may be difficult to place in a desired location within the image capture device. Also, cost considerations may limit the number of gyroscopes. Finally, the number of gyroscopes may be limited due to the desirability of limiting the overall size and/or cost of the image capture device.

In other image capture devices, an image is captured and then data corresponding to the captured image is analyzed to determine movement. In some, a series of successive images are analyzed. To save time and computational power, some image capture devices may capture and analyze smaller images or partial images having less data that a full sized image. However, in these image capture devices, image data analysis requires time for image data capturing and image data processing, and furthermore may require computational power that may place additional requirements on the processing device used in the image capture device.

### SUMMARY

One embodiment may comprise a first dual-axis linear accelerometer residing in the image capture device that senses a first acceleration in a first direction and that senses a first orthogonal acceleration in an orthogonal direction, a second dual-axis linear accelerometer residing in the image capture device that senses a second acceleration in the first direction and that senses a second orthogonal acceleration in the orthogonal direction, a processor that receives information from the first dual-axis linear accelerometer and the second dual-axis linear accelerometer such that the movement of the image capture device is determined.

Another embodiment is a method comprising sensing a first acceleration in a first direction and a first orthogonal acceleration in an orthogonal direction, sensing a second acceleration in the first direction and a second orthogonal acceleration in the orthogonal direction, determining a difference in acceleration between the first acceleration and the second acceleration, determining a difference in orthogonal acceleration between the first orthogonal acceleration and the second orthogonal acceleration, and determining the movement of the image capture device based upon the determined difference in acceleration and the determined difference in orthogonal acceleration.

### BRIEF DESCRIPTION OF THE DRAWINGS

The components in the drawings are not necessarily to scale relative to each other. Like reference numerals designate corresponding parts throughout the several views.

FIG. 1 is an illustrative diagram of an embodiment of the image capture device employing an aft dual-axis linear accelerometer and a fore dual-axis linear accelerometer.

FIG. 2 is an illustrative cut-away view of the image capture device embodiment of FIG. 1 employing the aft dual-axis linear accelerometer and the fore dual-axis linear accelerometer.

FIG. 3 is an illustrative diagram of the respective positioning and orientation of the aft dual-axis linear accelerometer and the fore dual-axis linear accelerometer.

FIG. 4 is a block diagram illustrating an exemplary embodiment of an acceleration detection system.

FIG. 5 is an illustrative diagram of the respective positioning and orientation of the aft dual-axis linear accelerometer and the fore dual-axis linear accelerometer in an alternative embodiment.

FIG. 6 is a flowchart illustrating an embodiment of a process for determining movement of an embodiment of the image capture device employing dual-axis linear accelerometer.

### DETAILED DESCRIPTION

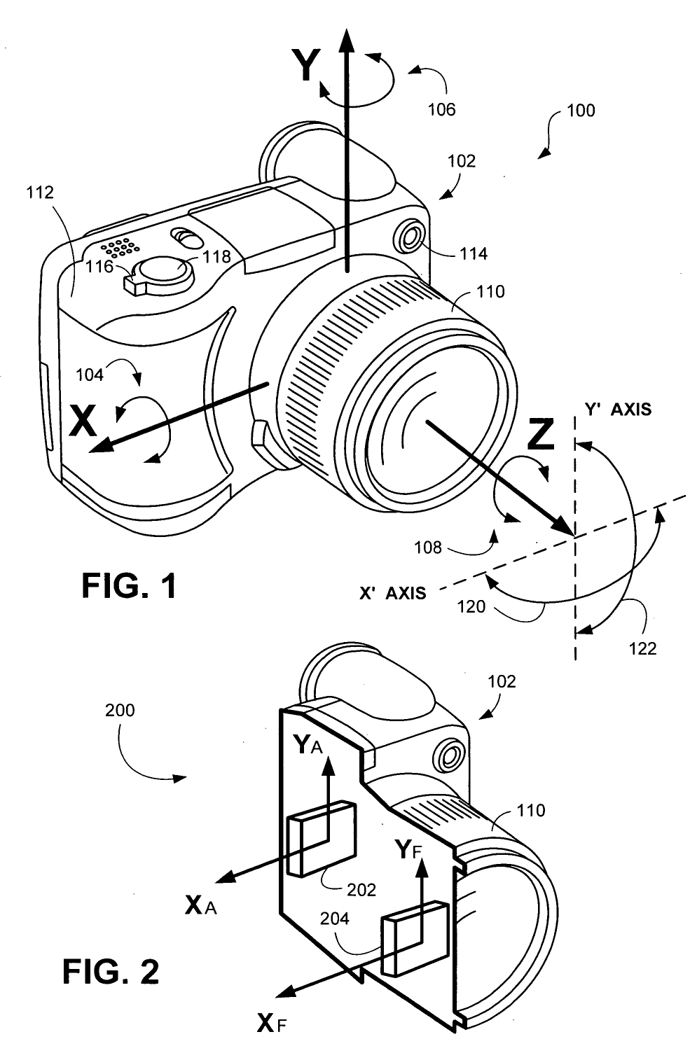

The acceleration detection system 100 (FIG. 1) provides a system and method for detecting image capture device movement. Detected movement by the acceleration detection system 100 may be used to generate information to provide higher quality captured images.

FIG. 1 is an illustrative diagram of an embodiment of the image capture device 102 employing an aft dual-axis linear accelerometer 202 (FIG. 2) and a fore dual-axis linear accelerometer 204 (FIG. 2). The aft dual-axis linear accelerometer 202 (FIG. 2) and the fore dual-axis linear accelerometer 204, described in greater detail hereinbelow, detect acceleration of the image capture device 102. The acceleration detected by the aft dual-axis linear accelerometer 202 (FIG. 2) and the fore dual-axis linear accelerometer 204 provides information used to determine information defining the movement of the image capture device 102.

A dual-axis linear accelerometer is configured to detect acceleration concurrently in two directions, the directions being at right angles (orthogonal) to each other. In a MEMS (micro-electro-mechanical system) device, the dual-axis linear accelerometer is constructed using solid state chip fabrication technology that enables fabrication of a relatively small physical device that detects acceleration. One type of MEMS-based dual-axis linear accelerometer employs one or more physical members that move when the dual-axis linear accelerometer body structure is subjected to an acceleration. Changes in capacitance between the physical member(s) that moves and a stationary member is detectable. The changes in capacitance can be measured to generate one or more corresponding signals. Analysis of the signals allow a determination of the acceleration.

In addition to the lens 110, an image capture device 102 comprises many other components, such as a body 112, a viewing lens 114, and a variety of image capture device operation controls. One illustrative controller [assuming the image capture device 102 is a digital camera having a display (not shown) and other related features] is a mode selection actuator 116 that, when rotated into various positions, controls such functions as image capture mode, preview mode, display mode and/or menu set mode. Another illustrative controller is the shutter button 118, which when actuated by depression by the user, causes image capture. In some types of digital or film-based image capture devices 100, partial depression of the shutter button 118 causes the image capture device 102 to operate in an automatic focus mode such that the lens 110 is adjusted to bring an object of interest into focus onto the image capture medium (not shown) residing in the image capture device 102.

In one embodiment, detected acceleration is used to compute movement information corresponding to rotational movement vector 104 along the X axis, rotational movement vector 106 along the Y axis, and rotational movement vector 108 along the Z axis. The illustrated X, Y and Z axes, and their associated rotational vectors 104, 106 and 108, respectively, are used for illustration purposes. The X, Y and Z axis are illustrated as being referenced with respect to the image capture device lens 110. It is appreciated that any other reference point on or within the image capture device 102 could have been used for illustration purposes. Furthermore, other coordinate systems may be used, such a polar coordinate system or other suitable coordinate system, to determine movement of the image capture device 102.

Axis Z, in the exemplary image capture device 102 of FIG. 1, is recognized as corresponding to the direction that lens 110 is pointing. Thus, an object of interest aligned along axis Z and within the view area of the image capture medium (not shown) will be captured when the image shutter button 118 is actuated. When movement is detected by the accelerometers 202 and 204, the movement may be of the type that changes the orientation (direction) of the Z axis. Rotational movement along the Y axis (see 106) or a shifting of linear position along the X axis will cause the lens 110 to change its field of view along the X′ axis, denoted by the directional arrow 120. Similarly, rotational movement along the X axis (see 104) or a shifting of linear position along the Y axis will cause the lens 110 to change its field of view along the Y′ axis, denoted by the directional arrow 122.

FIG. 2 is an illustrative cut-away view 200 of the image capture device 102 embodiment of FIG. 1 employing an aft dual-axis linear accelerometer 202 and a fore dual-axis linear accelerometer 204. During the process of automatic focus and/or during image capture, movement of the image capture device 102 may be undesirable. Accordingly, information from the aft dual-axis linear accelerometer 202 (FIG. 2) and the fore dual-axis linear accelerometer 204 may be used to determine compensating measures such that more desirable still or video images are captured.

The aft dual-axis linear accelerometer 202 resides in a location in a rear portion of the image capture device 102. In this exemplary embodiment, one axis of the aft dual-axis linear accelerometer 202 is oriented such that linear acceleration along the X_{A} axis is detected (wherein the X_{A} axis corresponds to the X axis of FIG. 1). The other axis of the aft dual-axis linear accelerometer 202 is oriented such that linear acceleration along the Y_{A} axis is detected (wherein the Y_{A} axis corresponds to the Y axis of FIG. 1).

The fore dual-axis linear accelerometer 204 resides in a location in a front portion of the image capture device 102. In this exemplary embodiment, one axis of the fore dual-axis linear accelerometer 204 is oriented such that linear acceleration along the X_{F} axis is detected (wherein the X_{F} axis corresponds to the X axis of FIG. 1). The other axis of the aft dual-axis linear accelerometer 202 is oriented such that linear acceleration along the Y_{F} axis is detected (wherein the Y_{F} axis corresponds to the Y axis of FIG. 1).

The terms “aft” and “fore” are arbitrarily defined herein to identify and describe relative location of the dual-axis linear accelerometers 202 and 204. As in a ship, the term “aft” corresponds to the rear or back portion of the ship. Similarly, the term “fore” corresponds to the front or leading portion of the ship. In the simplified embodiment of the image capture device 102 of FIG. 1, the front or leading portion of the image captured device 102 is referenced to that surface of the camera having the lens 110 and is identified as the “fore” portion. The rear or back portion (not visible in FIG. 1) of the image captured device 102 is referenced as the “aft” portion. It is appreciated that any suitable identifiers may be used to identify the relative locations of the image capture device 102 and/or to provide a convenient naming convention to distinguish between the two dual-axis linear accelerometers 202 and 204.

Also, the fore dual-axis linear accelerometer 204 is illustrated as residing within the lens 110. In other embodiments, the fore dual-axis linear accelerometer 204 may reside in a front portion of the body 112. These embodiment variations are described in greater detail below.

Summarizing the exemplary embodiment of FIG. 2, the dual-axis linear accelerometers 202 and 204 have an axis corresponding to a first direction of acceleration (the X axis corresponding to X_{A} and X_{F}) and wherein each have a second axis corresponding to an orthogonal direction of acceleration (the Y axis corresponding to Y_{A} and Y_{F}), and wherein the first direction of acceleration and the orthogonal direction of acceleration are perpendicular to the axis of direction corresponding to the orientation of a lens 110 (the Z axis) of the image capture device 102.

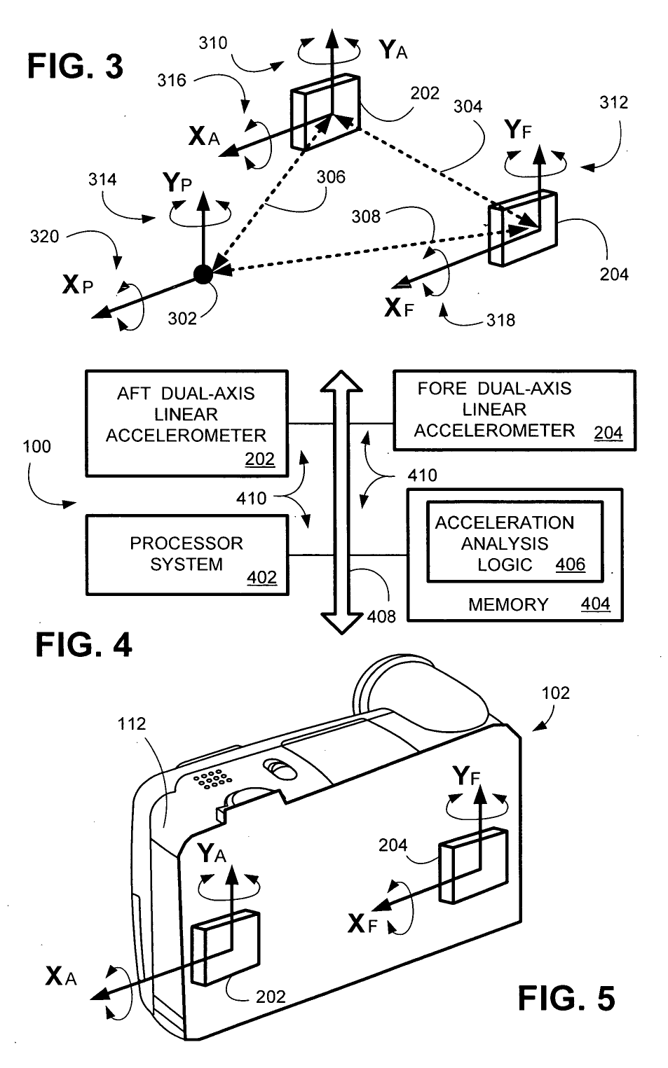

FIG. 3 is an illustrative diagram of the geometrical relationships of the positioning and orientation of the aft dual-axis linear accelerometer 202, the fore dual-axis linear accelerometer 204 and a selected reference point 302 within the image capture device 102 (FIGS. 1 and 2). The reference point 302 is a point of interest within the image capture device 102 wherein movement of the reference point 302 may be optionally determined based upon detected accelerations of the aft dual-axis linear accelerometer 202 and the fore dual-axis linear accelerometer 204. Determined movement may be linear along the W, Y or Z axis (FIG. 1), or a rotational movement along the rotational vectors 104, 106 and/or 108 (FIG. 1).

For example, reference point 302 may correspond to a known point associated with the image capture medium. If the image capture device embodiment compensates for detected movement by moving the image capture medium, the nature of the compensating movement of the image capture medium may be based upon the determined movement of reference point 302. As another example, reference point 302 may correspond to a known point associated with the lens 110 (FIG. 1). If the image capture device embodiment compensates for detected movement by moving one or more of the components residing in lens 110, the nature of the compensating movement of the image components may be based upon the determined movement of reference point 302. It is appreciated that the application of the determined movement of reference point 302 may be used for a variety of purposes. Furthermore, the reference point 302 may correspond to either of the dual-axis linear accelerometers 202 or 204.

The dual-axis linear accelerometers 202 and 204 are oriented with respect to each other by a known distance and orientation, illustrated by vector 304. The aft dual-axis linear accelerometer 202 and the reference point 302 are oriented with respect to each other by another known distance and orientation, illustrated by vector 306. The fore dual-axis linear accelerometer 204 and the reference point 302 are oriented with respect to each other by another known distance and orientation, illustrated by vector 308. The distance and orientation of vectors 304, 306 and 308 may be described using any suitable vector coordinate system, such as, but not limited to, polar coordinates or Cartesian coordinates.

When the image capture device is moved in a direction along its respective X axis (FIG. 1), the aft dual-axis linear accelerometer 202 detects an acceleration along the X axis, denoted as X_{A}. Concurrently, the fore dual-axis linear accelerometer 204 detects an acceleration along its respective X axis, denoted as X_{F}. The difference between X_{A} and X_{F} is used to determine rotation about the Y axis (FIG. 1). The difference may be determined using known trigonometric, geometric and calculus algorithms. Such known trigonometric, geometric and/or calculus algorithms are not described herein for brevity.

Accordingly, a rotational vector 310 (about the Y axis) associated with the aft dual-axis linear accelerometer 202 may be determined. Similarly, a rotational vector 312 (about the Y axis) associated with the fore dual-axis linear accelerometer 204 may be determined. Because the vectors 304, 306 and 308 are known, a rotational vector 314 associated with the reference point 302 (about its respective Y axis) may be determined using known trigonometric, geometric and calculus algorithms. Furthermore, the acceleration of the reference point 302 along the X axis, denoted as X_{P} is determinable using known trigonometric, geometric and calculus algorithms.

When the image capture device is moved in a direction along the Y axis (FIG. 1), the aft dual-axis linear accelerometer 202 detects an acceleration along its respective Y axis, denoted as Y_{A}. Concurrently, the fore dual-axis linear accelerometer 204 detects an acceleration along its respective Y axis, denoted as Y_{F}. The difference between Y_{A} and Y_{F} is used to determine rotation about the X axis (FIG. 1) using known trigonometric, geometric and calculus algorithms.

Accordingly, a rotational vector 316 (about the X axis) associated with the aft dual-axis linear accelerometer 202 may be determined. Similarly, a rotational vector 318 (about the X axis) associated with the fore dual-axis linear accelerometer 204 may be determined. Because the vectors 304, 306 and 308 are known, a rotational vector 320 associated with the reference point 304 (about its respective X axis) may be determined using known trigonometric, geometric and calculus algorithms. Furthermore, the acceleration of the reference point 302 along the Y axis, denoted as Y_{P} is determinable using known trigonometric, geometric and calculus algorithms.

FIG. 4 is a block diagram illustrating an exemplary embodiment of an acceleration detection system 100. The acceleration detection system comprises an aft dual-axis linear accelerometer 202, a fore dual-axis linear accelerometer 204, a processor system 402, and a memory 404. The acceleration analysis logic 404 resides in memory 404. Other logic related to the image capture device may also reside n memory 404.

For convenience, an aft dual-axis linear accelerometer 202, fore dual-axis linear accelerometer 204, processor system 402, and memory 404 are illustrated as communicatively coupled to each other via communication bus 408 and connections 410, thereby providing connectivity between the above-described components. In alternative embodiments, the above-described components are connectivley coupled in a different manner than illustrated in FIG. 4. For example, one or more of the above-described components may be directly coupled to each other or may be coupled to each other via intermediary components (not shown).

When the image capture device 102 (FIGS. 1 and 2) moves, aft dual-axis linear accelerometer 202 and fore dual-axis linear accelerometer 204 detect acceleration associated with the movement. Acceleration is detected along their respective X axis (X_{A} and X_{F}, respectively), and along their respective Y axis (Y_{A} and Y_{F}, respectively). This information is communicated to the processor system 402 such that when the acceleration analysis logic 406 is executed by processor system 402, movement of the image capture device 102 as described above is determined.

Processor system 402 controls execution of a program, described herein as the acceleration analysis logic 406, employed by embodiments of the acceleration detection system 100. It is appreciated that any suitable processor system 402 may be employed in various embodiments of a acceleration detection system 100. Processor system 404 may be a specially designed and/or fabricated processing system, or a commercially available processor system. Non-limiting examples of commercially available processor systems include, but are not limited to, an 80×86 or Pentium series microprocessor from Intel Corporation, U.S.A., a PowerPC microprocessor from IBM., a Sparc microprocessor from Sun Microsystems, Inc., a PA-RISC series microprocessor from Hewlett-Packard Company, or a 68xxx series microprocessor from Motorola Corporation. In alternative embodiments, the parts of or all of the above described-components may be implemented as firmware or a combination of firmware and software.

FIG. 5 is an illustrative diagram of the respective positioning and orientation of the aft dual-axis linear accelerometer 202 and the fore dual-axis linear accelerometer 204 in an alternative embodiment. As noted above, movement of any point of interest 302 (FIG. 3) may be determined from information provided by two dual-axis linear accelerometers so long as their respective geometries of the dual-axis linear accelerometers and the point of interest are known. Accordingly, two (or more) dual-axis linear accelerometers may be located at other locations within the image capture device 102.

Furthermore, the orientation of the dual-axis linear accelerometers 202 and 204 were described as being oriented along the X axis and the Y axis (FIG. 1). In other embodiments, the dual-axis linear accelerometers 202 and 204 may be oriented along other axis since so long as the respective geometries of the dual-axis linear accelerometers 202 and 204, and/or the point of interest, are known, movement may be determined.

In the embodiment described in FIG. 1, the fore dual-axis linear accelerometer 204 was described as residing within the lens 110. Locating the dual-axis linear accelerometer 204 in the lens 110 increases the length associated with vector 304 (FIG. 3) (and/or the length associated with vector 308). Accordingly, it is appreciated that the accuracy of the determined movement is greater because of the increased length of vector 304 (and/or vector 308).

Furthermore, some lens 110 may move. For example, some embodiments of an image capture device include retractable lens to facilitate a more compact configuration when not in use. The lens is configured to extend outward for operation. Other embodiments employ telescoping lens to adjust the field of view (magnification or the like) and/or autofocus lens to facilitate image focusing. Accordingly, when the lens 110 extends outward, a fore dual-axis linear accelerometer 204 residing in the lens 110 also moves to a more outward location, thereby increasing the distance of the vector 304 (and/or vector 308). Thus, more accurate detection of movement is facilitated based upon the geometry of the extended length of vector 304 (and/or vector 308). In such embodiments, other sensors may be required to determine the length and/or orientation vector 304 (and/or vector 308). Or, the change in length and/or orientation of the vector 304 (and/or vector 308) due to the extension of lens 110 may be known based upon the design of the image capture device 102.

For convenience, the movement of the image capture device 102 was described in terms of the X, Y, and Z axis (FIG. 1) and in terms of the rotational movement vectors 104, 106 and 108 for the dual-axis linear accelerometers 202 and 204, and the point of interest 302. In some arts, the terms “pitch” and “yaw” may be used to describe movement of an image capture device. The above-described movement of the image capture device 102 may also be defined using the terms pitch and/or yaw. Accordingly, the above-described detection of acceleration is used to determine movement in terms of pitch and yaw using known trigonometric, geometric and/or calculus algorithms. Such determination of movement in terms of yaw and pitch, or in other terms used in the arts, is not described herein for brevity.

As noted above, some types of image capture devices employ a system that moves the position of the image capture medium to compensate for movement. In alternative embodiments, the aft dual-axis linear accelerometer 202 is located on the image capture medium or the image capture medium movement actuator. Accordingly, more precise movement of the image capture movement may be determined. Also, the effectiveness of the compensation measures may be determined by such embodiments. For example, one embodiment may utilize a feedback loop that determines a differential signal. Thus, the image capture medium will be further stabilized by the associated stabilization control system.

With respect to the figures, the dual-axis linear accelerometers 202 and 204 may appear to be illustrated as being in alignment with each other along the Z axis. In some embodiments, the dual-axis linear accelerometers 202 and 204 may be offset from each other along the X axis and/or the Y axis. Accordingly, a known offset between the dual-axis linear accelerometers 202 and 204 along the X axis and/or the Y axis still allows a determination of the vectors 306, 306 and/or 308 (FIG. 3).

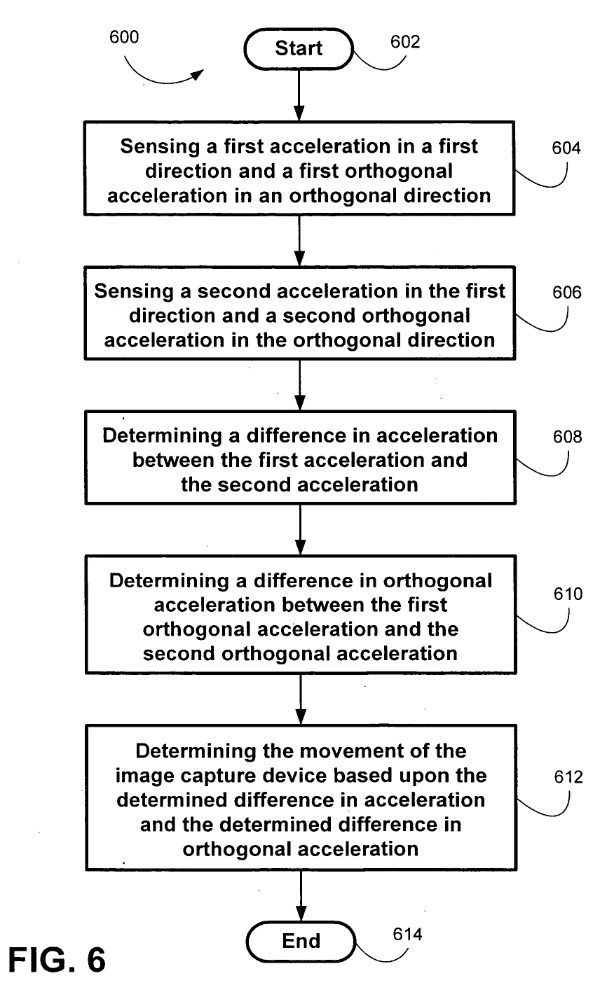

FIG. 6 is a flowchart illustrating an embodiment of a process for determining movement of an embodiment of the image capture device employing dual-axis linear accelerometer. The flow chart 600 of FIG. 6 shows the architecture, functionality, and operation of an embodiment for implementing the acceleration analysis logic 406 (FIG. 6) such that movement of the image capture device is determinable. An alternative embodiment implements the logic of flow chart 600 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIG. 6, or may include additional functions. For example, two blocks shown in succession in FIG. 6 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the disclosure.

The process begins at block 602. At block 604, a first acceleration is sensed in a first direction and a first orthogonal acceleration in an orthogonal direction. At block 606, a second acceleration is sensed in the first direction and a second orthogonal acceleration in the orthogonal direction. At block 608, a difference is determined in acceleration between the first acceleration and the second acceleration. At block 610, a difference is determined in orthogonal acceleration between the first orthogonal acceleration and the second orthogonal acceleration. At block 612, the movement of the image capture device is determined based upon the determined difference in acceleration and the determined difference in orthogonal acceleration. The process ends at block 614.

As described hereinabove, the dual-axis linear accelerometers 202 and 204 detect acceleration of the image capture device. In the various embodiments, the difference in acceleration along one of the axis corresponds can be determined, thereby yielding rotational acceleration along the axis. Integration over time of the rotational axis yields rotational velocity along the axis. Integration of the rotational velocity yields a change in rotational position.

Embodiments of the acceleration detection system 100 (FIG. 1) implemented in memory 404 (FIG. 4) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

It should be emphasized that the above-described embodiments are merely examples of the disclosed system and method. Many variations and modifications may be made to the above-described embodiments. All such modifications and variations are intended to be included herein within the scope of this disclosure.

What is claimed is:

1. A system that determines movement in an image capture device, comprising:
a first dual-axis linear accelerometer residing in the image capture device that senses a first acceleration in a first direction and that senses a first orthogonal acceleration in an orthogonal direction;
a second dual-axis linear accelerometer residing in the image capture device that senses a second acceleration in the first direction and that senses a second orthogonal acceleration in the orthogonal direction; and
a processor that receives information from the first dual-axis linear accelerometer and the second dual-axis linear accelerometer such that the movement of the image capture device is determined.

2. The system of claim 1, wherein the first dual-axis linear accelerometer comprises an aft dual-axis linear accelerometer residing in a rear portion of the image capture device.

3. The system of claim 1, wherein the second dual-axis linear accelerometer comprises a fore dual-axis linear accelerometer residing in a front portion of the image capture device.

4. The system of claim 3, wherein the fore dual-axis linear accelerometer resides in the front portion of a body of the image capture device.

5. The system of claim 3, wherein the fore dual-axis linear accelerometer resides in a lens of the image capture device.

6. The system of claim 1, wherein the first dual-axis linear accelerometer and the second dual-axis linear accelerometer each have a first axis corresponding to the first direction of acceleration and wherein each have a second axis corresponding to the orthogonal direction of acceleration, and wherein the first direction of acceleration and the orthogonal direction of acceleration are perpendicular to an axis of direction corresponding to the orientation of a lens of the image capture device.

7. The system of claim 1, wherein the first dual-axis linear accelerometer and the second dual-axis linear accelerometer are micro-electro-mechanical system (MEMS) devices.

8. The system of claim 1, further comprising a film-based camera wherein the first dual-axis linear accelerometer, the second dual-axis linear accelerometer and the processor reside.

9. The system of claim 1, further comprising a digital camera wherein the first dual-axis linear accelerometer, the second dual-axis linear accelerometer and the processor reside.

10. The system of claim 1, further comprising a video camera wherein the first dual-axis linear accelerometer, the second dual-axis linear accelerometer and the processor reside.

11. A method for determining movement of an image capture device, comprising:
sensing a first acceleration in a first direction and a first orthogonal acceleration in an orthogonal direction;
sensing a second acceleration in the first direction and a second orthogonal acceleration in the orthogonal direction;
determining a difference in acceleration between the first acceleration and the second acceleration;
determining a difference in orthogonal acceleration between the first orthogonal acceleration and the second orthogonal acceleration; and
determining the movement of the image capture device based upon the determined difference in acceleration and the determined difference in orthogonal acceleration.

12. The method of claim 11, wherein sensing the first acceleration and the first orthogonal acceleration is sensed with a first dual-axis linear accelerometer residing in the image capture device, and wherein sensing the second acceleration and the second orthogonal acceleration is sensed with a second dual-axis linear accelerometer residing in the image capture device.

13. The method of claim 12, further comprising moving a lens of the image capture device from a retracted position to an extended position such that the second dual-axis linear accelerometer is moved from a first location to a second location.

14. The method of claim 11, further comprising determining movement of a reference point based upon the determined movement of the image capture device.

15. The method of claim 11, further comprising determining movement of a reference point based upon the determined difference in acceleration and the determined difference in orthogonal acceleration.

16. A system for determining movement of an image capture device, comprising:
means sensing a first acceleration in a first direction and a first orthogonal acceleration in an orthogonal direction;
means for sensing a second acceleration in the first direction and a second orthogonal acceleration in the orthogonal direction;
means for processing information corresponding to a difference in acceleration between the first acceleration and the second acceleration;
means for determining a difference in orthogonal acceleration between the first orthogonal acceleration and the second orthogonal acceleration; and
means for determining the movement of the image capture device based upon the determined difference in acceleration and the determined difference in orthogonal acceleration.

17. The system of claim 16, further comprising means for moving a lens of the image capture device from a retracted position to an extended position such that the means for sensing the second acceleration is moved from a first location to a second location.

18. The system of claim 16, further comprising means for determining movement of a reference point based upon the determined movement of the image capture device.

19. The system of claim 16, further comprising means for determining movement of a reference point based upon the determined difference in acceleration and the determined difference in orthogonal acceleration.

20. A program for determining movement of an image capture device stored on computer-readable medium, the program comprising logic configured to perform:
receiving information corresponding to a sensed first acceleration in a first direction and a sensed first orthogonal acceleration in an orthogonal direction;
receiving information corresponding to a sensed second acceleration in the first direction and a sensed second orthogonal acceleration in the orthogonal direction;
determining a difference in acceleration between the sensed first acceleration and the sensed second acceleration;
determining a difference in orthogonal acceleration between the sensed first orthogonal acceleration and the sensed second orthogonal acceleration; and
determining the movement of the image capture device based upon the determined difference in acceleration and the determined difference in orthogonal acceleration.

21. The program of claim 20, the program further comprising logic configured to perform determining information corresponding to movement of a lens of the image capture device from a retracted position to an extended position such that the determined movement corresponds to the movement of the lens.

22. The program of claim 20, the program further comprising logic configured to perform determining movement of a reference point based upon the determined movement of the image capture device.

23. The program of claim 20, the program further comprising logic configured to perform determining movement of a reference point based upon the determined difference in acceleration and the determined difference in orthogonal acceleration.
